(19) United States
(12) Patent Application Publication
(10) Pub. No.: US 2002/0069368 A1
(43) Pub. Date: Jun. 6, 2002

(54) Data farming of network access

(76) Inventor: Keith Hines, Phoenix, AZ (US)

Correspondence Address: WEISS & MOY PC, 4204 NORTH BROWN AVENUE, SCOTTSDALE, AZ, 85251, US

(21) Appl. No.: 09/730,922

(22) Filed: Dec. 6, 2000

Related U.S. Application Data
(60) Provisional application No. 60/169,694, filed on Dec. 7, 1999.

(51) Int. Cl. G06F 11/30

(52) U.S. Cl. 713/201

(57) ABSTRACT

A method and system for collecting network access information is referred to as Data Farming. A user establishes a user profile which includes a set of unique log on credentials and certain demographic information. The user profiles are stored in a database. Each time a user connects to the network, the user provides their credentials for authentication and tracking. Every time the user accesses the network, the details of the access are logged against the corresponding user credentials as well as the date and time. Network access information includes specific Universal Resource Locator (URL) accessed, the page of the URL, and the parameters passed to the page of the URL. In addition, logging of the actual web page source code for instances where the parameters of the page need to be interpreted. All network access is forced to pass through a logging apparatus consists of either software/hardware on the user's computer or software/hardware in the network or a combination thereof.

### CROSS RELATED APPLICATIONS

This application claims priority of the provisional U.S. Patent Application entitled DATA FARMING OF NETWORK ACCESSES, filed on Dec. 7, 1999 and having application No. 60/169,694.

### BACKGROUND OF THE INVENTION

1. Field of the Invention

The invention generally relates to the collection of network access parameters in relation to a specific user at a date and time. Specifically, the web location or Universal Resource Locator (URL), web page, and parameters that each user accesses during a session on a network.

2. Description of the Related Art

The tracking individual user access to a variety of mediums in order to determine habits of demographic groups has been common practice in the advertising industry. For example, the tracking of television viewership is used to determine the value of commercial air time as well as the target audience of the television program. The tracking the demographics of magazine readers is similarly used to determine advertisement rates and target audiences. Recently retail stores have started to track the buying habits of consumers in order to market to specific groups of people with targeted products and services. After sale registration of purchased items are used for the similar tracking purposes.

Therefore, a need exists to provide a more advantageous system and method for tracking access of network information such as access of Internet web sites.

### BRIEF SUMMARY

One embodiment of the present invention provides a method for tracking network access to the particular URL, page and parameters entered by or assigned to individual users. The date and time of each access is logged along with the unique user, the URL, the page of the URL, and the parameters passed to that page. In some instances, one embodiment of the present invention logs the actual page returned.

In one embodiment of the present invention, each individual user must create a profile comprising a set of unique user credentials (e.g. user name and password) and certain of demographic information (e.g. date of birth, gender, location, etc.) prior to the gathering and collection of network access information and/or parameters. Each user profile is stored in a non-volatile repository (database) for later use in authenticating and network access logging.

When a user accesses the system provided for under the various embodiments of the present invention, the user must authenticate the previously created unique individual credentials during the log on process and prior to accessing the network. This method of access is called a forced log on. After log on, each access made to the network is stored to some form of a database including the URL, the page, and the parameters sent to the page, and sometimes the actual source of the page. In storing each access, the identity of the user, as well as the date and time of the access are stored as well.

Once the data is collected and stored, various statistical models or mappings can be created to include such possibilities as access versus demographic groups versus date/time and access versus a unique individual versus date/time. In addition to the statistical models and mappings, the actual parameters used in the access are available. This raw data can be used to determine or predict the behavior of individual users (e.g. items purchased at an on-line store, travel arrangements, search parameters, etc.).

The foregoing and other objects, features, and advantages of the invention will be apparent from the following, more particular, description of the preferred embodiments of the invention, as illustrated in the accompanying drawings.

### BRIEF DESCRIPTION OF THE SEVERAL VIEWS OF THE DRAWINGS

FIG. 1 is a block diagram of one embodiment of the present invention illustrating as a system comprising a set components used in forcing a log on, forcing network traffic through a collection apparatus (i.e. proxy) and collecting data and/or parameters from a plurality of network accesses and storing the collected data in a database connected to the collection apparatus;

FIG. 2 is a block diagram illustrating another embodiment of the present invention illustrating a system comprising a set of components used in forcing a log on, forcing network traffic through a collection apparatus (i.e. user's computer) and collecting data and/or parameters from a plurality of network accesses and storing the collected data in a database residing within the collection apparatus;

FIG. 3 is a flow chart of one method of the present invention illustrating the steps for creating the a unique, individual user profile; and

FIG. 4 is a flow chart of another method of the present invention illustrating the steps used in collecting a plurality of access data associated with each user.

### DETAILED DESCRIPTION

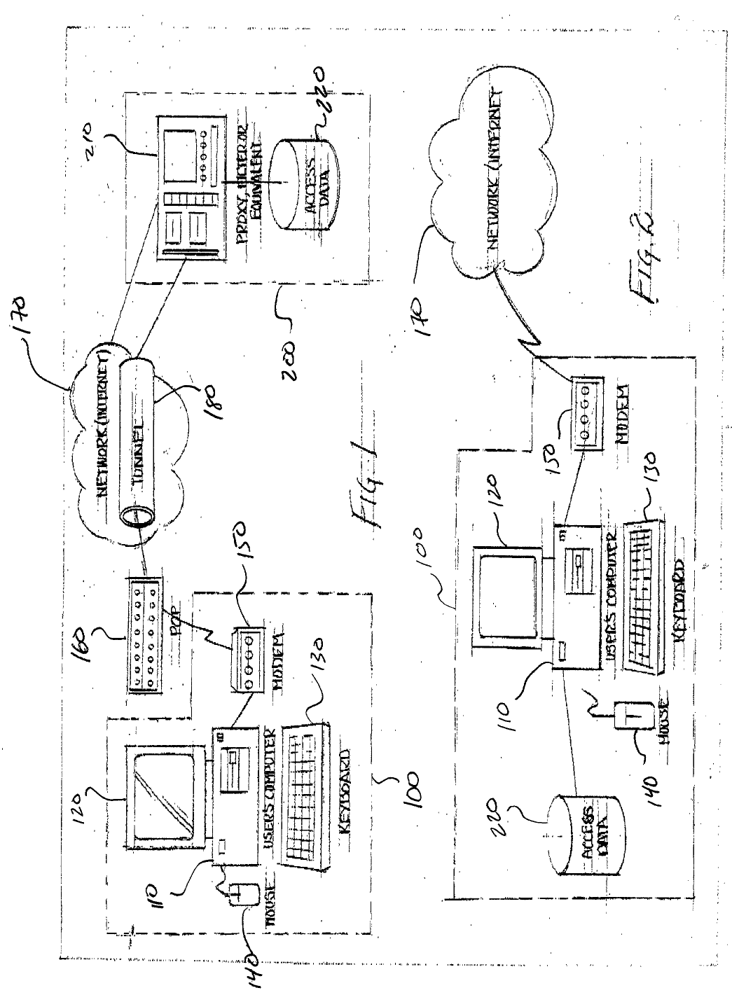

Referring to FIG. 1, one embodiment of the present invention is illustrated in a block diagram. A user location 100, which in many cases will be the user's home or place of business, is comprised of a computational or processing device capable of network or Internet access, such as a personal computer 110.

Although a desktop personal computer 110 is illustrated in FIG. 1, it will be understood that a portable computer such as a laptop or notebook, a “dumb” terminal, a hand held computer such as a personal digital assistant (PDA), or a wireless telephone can also comprise various embodiments of the present invention, for data farming network access. In addition, a workstation on a local area network at the user location can be used instead of personal computer 110 for data farming network access.

The personal computer 110 is employed to access a network or Internet (e.g. world-wide-web). In the embodiment illustrated, the personal computer 110 is generally conventional in design, comprising a processor chassis within which is disposed a central processing unit (CPU), supporting integrated circuitry, and data storage capability (e.g. RAM and disk drive). A display monitor 120, a keyboard 130 and an optional mouse 140 are connected to the personal computer 110.

The personal computer 110 is controlled by the user using the keyboard 130 and the mouse 140 or other equivalent selection device that controls a cursor that is moved about on the screen of the monitor 120 to make selections of programs executing on the personal computer 110. The personal computer 110 connects to a network 170 via a modem 150 or other type of communication device or method. The modem 150 and a server, such as a POP server 160, provide the means for the user to interact with the network 170.

While the embodiment of the present invention illustrated in FIG. 1 has a personal computer 110 which communicates with the network 170 through modem 150 and POP server 160, the communication could be through a private or local network which is connected to the target network (i.e. Internet). Similarly, a high-speed data connection, such as Direct Subscriber Line (DSL) is foreseeable within another embodiment of the present invention.

The network (e.g. Internet) 170 is depicted in FIG. 1 as an amorphous shape in order to indicate that it is a complex system, which can involve thousands of nodes and components, conveying signals by land lines, satellite, radio waves and/or optical fibers.

A tunnel 180 forces all data (traffic, packets, blocks, etc.) to route through the network 170 to a specific destination such as a proxy location 200. The proxy location 200 is comprised of a proxy 210 and a database 220. The proxy 210 is a computer, similar to a server, which is comprised of at least one CPU, support circuitry, memory (RAM and disk drive) and custom software. Alternative to a server, the proxy 210 could also comprise a custom hardware device. The database 220 resides on a storage medium which is connected to or contained within, the proxy 210.

The proxy 210 makes access to the network 170 on behalf of the user. The proxy 210 receives all data (packets, blocks, etc.) which the user transmits to the network (e.g. Internet). The proxy 210 sends all of the user transmissions to the network 170, as though they were transmitted by user. The proxy 210 examines all user transmission data to determine access information. The proxy 210 logs to database 220 the parameters of all network accesses made by the user including the current date, current time, unique user identification, the point of access (i.e. URL), the specific page, and the specific parameters to the page.

The proxy 210 is specified in the illustrated embodiment of the present invention as a ‘proxy’ or ‘transparent proxy’, however, that any device that can analyze and store network access parameters can be used. The database 220, is specified in the illustrated embodiment of the present invention has the property that it can store data in an organized manner which can be retrieved at some later time. The database 220, is shown as a singular storage entity. However, the database 220 may be multiple, linked entities. The database 220, contains all network access information and/or parameters, by all users, as well as, each unique user profile.

One component, which is not part of the present invention, is the routing of the user to the proxy as shown in FIG. 1. Standard routing and tunneling protocols are used. This can be as simple as setting a proxy in the users network access software.

Referring to FIG. 2, wherein like reference numerals refer to like components, another embodiment of the present invention is illustrated. The user location 100 is comprised of the personal computer 110, display monitor 120, keyboard 130, optional mouse 140, and modem 150, similar to the system of FIG. 1. The personal computer 110 connects to the network 170 via the modem 150 or other type of network connection means as described above.

In the present embodiment, the database 220 comprising user profile data and access data, is stored within the personal computer 110 or on a peripheral device connected to the personal computer 110, such as an external disk drive. The proxy of the previous embodiment is no longer utilized.

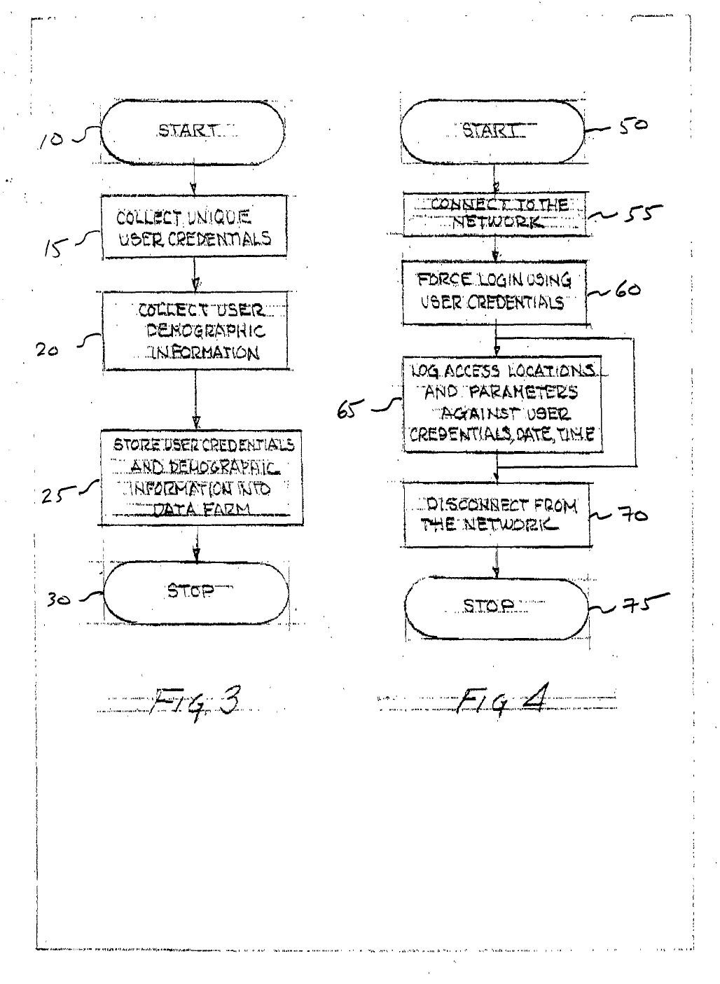

FIG. 3 illustrates one method of the steps to initiate or create a user profile. The steps as illustrated in FIG. 3 execute on the systems as described above and are completed for each unique individual user. The start block 10 initializes the program. A subsequent step 15 collects a set of credentials, such as name, address, other contact information, username, password and any other data which can be used to uniquely identify and authenticate a user. Subsequently step 20 collects certain demographic information pertaining to each user. The minimum set of data for step 20 consists of a date of birth, gender, and location of the user. Then step 25 stores the user profile which is comprised of credential and demographic data in the database shown in FIGS. 1 and 2. Step 30 completes the method. The method is repeated for each user. Also, the order of steps 15 and 20 are not critical to the present method.

Referring to FIG. 4, a method for capturing and storing user activity on a network is shown. After the user profile is created using the method of FIG. 3, data farming network access by the user can be accomplished on the systems as described above and using a method as illustrated in FIG. 4. Access to the network by the user begins with start block 50 which initializes the program. Subsequently, in step 55, the user must connect to the network through such means as a dial up modem, unless a dedicated network connection such as DSL exists. In step 60, the user is forced to log on using previously established credentials. Step 60 is complete when a set of unique credentials is presented by the user and they are authenticated. Step 60 continues until authentication of a user is successful.

In step 65, the user accesses the network through the proxy or through the personal computer, depending on the particular embodiment of the system employed. The user transmits and receives information from elements of the network. The proxy or personal computer stores each access to the database including the unique user, date, time and the specific access information (location, page, parameters) as shown by the looping of block 65. Subsequently, the user requests to stop accessing the network, in which case step 70 terminates the network connection. Step 75 completes the method. In addition, in the present invention, connecting and disconnecting from the network can be construed as connecting and disconnecting with the proxy.

Although the invention has been particularly shown and described with reference to a preferred embodiment thereof, it will be understood by those skilled in the art that changes in form and detail may be made therein without departing from the spirit and scope of the invention.

What is claimed is:

1. A system for collecting network access information, comprising:
means for creating a user profile;
means for storing the user profile;
means for forcing a log on to the system by authenticating the user profile with respect to a plurality of log on data;
means for accessing a network;
means for tracking a plurality of network access parameters;
means for storing the plurality of network access parameters; and
means for correlating the plurality of network access parameters to the user profile.

2. The system in accordance with claim 1 wherein the user profile comprises:
a plurality of user credentials; and
a plurality of demographic information relevant to the user credentials.

3. The system in accordance with claim 2 wherein the user credentials comprise:
a profile user name; and
a profile password.

4. The system in accordance with claim 2 wherein the plurality of demographic information comprises:
a date of birth of the user:
a gender of the user; and
a location of the user.

5. The system in accordance with claim 1 wherein the plurality of log on data comprises:
a log on user name; and
a log on password.

6. The system in accordance with claim 1 wherein the plurality of network parameters comprises:
a Universal Resource Locator (URL);
a date on which the URL was accessed; and
a time at which the URL was accessed.

7. The system in accordance with claim 6 wherein the plurality of network parameters further comprises:
a page within the URL; and
at least one parameter that is entered by the user and transmitted to the URL.

8. The system in accordance with claim 1 wherein the means for tracking the plurality of network access data is comprised of a proxy.

9. The system in accordance with claim 1 wherein the means for storing the plurality of network access data is comprised of a database.

10. The system in accordance with claim 1 wherein the means for accessing the network is coupled to the means for tracking the plurality of network access data by a tunnel.

11. The system in accordance with claim 10 wherein the proxy logs the plurality of network access parameters to the database.

12. A method for collecting network access information comprising the steps of:
initiating a user profile; and
capturing and storing user activity on a network.

13. The method in accordance with claim 12 wherein the step of initiating the user profile comprises the steps of:
collecting a plurality of user credentials; and
collecting a plurality of demographic information relevant to the user credentials; and
storing the plurality of user credentials and the plurality of demographic information.

14. The method in accordance with claim 12 wherein the step of capturing and storing user activity on a network comprises the steps of:
connecting a user location to the network;
logging on a user to the user location by authenticating log on data with respect to the user profile;
accessing the network at particular locations;
collecting a plurality of network access parameters;
storing the plurality of network access parameters; and
correlating the plurality of network access parameters to the user profile.

15. The method in accordance with claim 14 further comprising the step of disconnecting the user location from the network.
